(19) United States
(12) Patent Application Publication
(10) Pub. No.: US 2026/0259995 A1
(43) Pub. Date: Sep. 3, 2026

(54) VULNERABILITY REMEDIATION WITH MACHINE LEARNING AGENT

(71) Applicant: BOOST SUBSCRIBERCO L.L.C., Englewood, CO (US)

(72) Inventors: Harish Gowda Huthanahalli Kumarswamy, Bangalore (IN); Anand Dwaraka Upendra, Bangalore (IN)

(21) Appl. No.: 19/068,778

(22) Filed: Mar. 3, 2025

(51) Int. Cl. G06F 21/57; G06F 21/55

(52) U.S. Cl. CPC G06F 21/577; G06F 21/552

(57) ABSTRACT

Aspects of the described technology may provide an artificial intelligence (AI) based IT system security vulnerability remediation system. Aspects may include a method, including: obtaining an information technology (IT) system inventory dataset; obtaining a vulnerability dataset; determining a vulnerability for remediation based on the vulnerability dataset and the IT system inventory dataset; evaluating the IT system inventory dataset using a reinforcement machine learning agent to determine a remediation confidence score for the vulnerability; evaluating the confidence score and the IT system inventory dataset using a supervised machine learning agent to determine a remediation action for the vulnerability; performing the remediation action; and updating the reinforcement machine learning agent based on an outcome of performing the remediation action.

### BACKGROUND

A security vulnerability is a weakness in a security system that can be exploited by a threat agent to compromise an application, network, or other aspect of an information technology (IT) system. Some examples of security vulnerabilities include: application vulnerabilities that can be caused by design, implementation, or configuration failures; broken authentication when attackers can compromise passwords, keys, session tokens, or other secrets to assume user identities, zero day vulnerabilities, remote code execution (RCE), exploitable poor data sanitization, misconfigurations, vulnerable APIs or unpatched software, unauthorized access, credential theft, cryptographic failures, code injection, etc.

### SUMMARY

Aspects of the described technology may provide an artificial intelligence (AI) based IT system security vulnerability remediation system. Aspects may include a method, including: obtaining an IT system inventory dataset; obtaining a vulnerability dataset; determining a vulnerability for remediation based on the vulnerability dataset and the IT system inventory dataset; evaluating the IT system inventory dataset using a reinforcement machine learning agent to determine a remediation confidence score for the vulnerability; evaluating the confidence score and the IT system inventory dataset using a supervised machine learning agent to determine a remediation action for the vulnerability; performing the remediation action; and updating the reinforcement machine learning agent based on an outcome of performing the remediation action.

Further aspects may provide a systems, including at least one processor; a non-transitory computer readable medium storing instructions executable by the at least one processor to: obtain an information technology (IT) system inventory dataset; obtain a vulnerability dataset; determine a vulnerability for remediation based on the vulnerability dataset and the IT system inventory dataset; evaluate the IT system inventory dataset using a reinforcement machine learning agent to determine a remediation confidence score for the vulnerability; evaluate the confidence score and the IT system inventory dataset using a supervised machine learning agent to determine a remediation action for the vulnerability; output the remediation action; receive an outcome of performing the remediation action; and update the reinforcement machine learning agent based on the outcome.

### BRIEF DESCRIPTION OF THE DRAWINGS

FIG. 1 is a flowchart illustrating an example method for IT system security.

FIG. 2 is a example flowchart illustrating various aspects of an AI vulnerability management architecture.

FIG. 3 illustrates aspects of an implementation of an AI vulnerability management architecture.

FIG. 4 illustrates an example process flow for feedback processes in a system.

FIG. 5 illustrates an example method of using a trained machine learning agent for AI vulnerability management.

FIG. 6 illustrates an example method of training a machine learning agent for AI vulnerability management.

FIG. 7 shows an example of a system for vulnerability remediation in accordance with some embodiments described in the present disclosure.

FIG. 8 shows an example of a system for vulnerability remediation in accordance with some embodiments described in the present disclosure.

### DETAILED DESCRIPTION

As used herein, the term “dataset” refers to any set of data independent of the manner/format that the data is stored or obtained. For example, a dataset may include structured data, unstructured data, combinations thereof, etc. A dataset is not necessarily stored in a single/common location. For instance, a dataset may comprise data retrieved from multiple sources, data organized into multiple files/structures, etc.

Security vulnerabilities represent weaknesses in a system that malicious actors can exploit to gain unauthorized access, steal data, disrupt operations, or cause other harm, essentially creating an open door for cyberattacks and potentially leading to significant damage to IT systems, financial losses, reputational damage, and legal issues for an organization. Security vulnerabilities may be present at any possible attack surface. Attempting a particular remedy may have cascading impacts across a system. For example, unsuccessfully implementing a patch can cause significant disruption across a network, application, or other aspect of an IT system. As another example, misconfiguring a firewall can cause significant service loss/disruption.

Aspects of the described technology address these and other challenges with respect to security vulnerability management. For example, machine learning agents may be used to determine potential vulnerability remediation actions and implement such remediations without disruption to production systems.

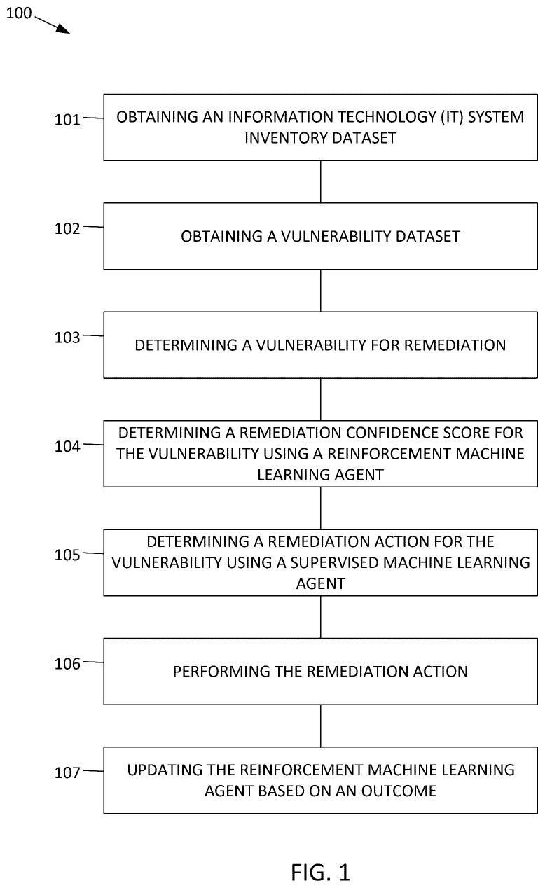

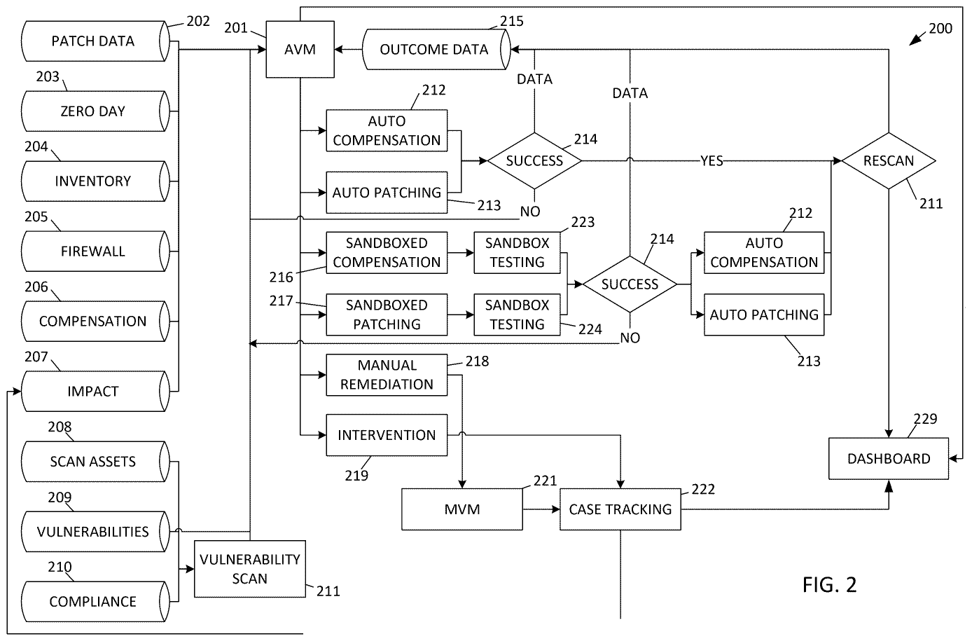

FIG. 1 is a flowchart illustrating an example method 100 for IT system security. For example, method 100 may be performed by an organizational IT system operations management or dedicated security computer system. For instance, method 100 may be performed in an architecture such as illustrated in FIG. 2. Although some examples are described with respect to performance of the method by a single computer, the technology may be performed via a distributed computing system, virtualized computing system, or any other suitable architecture.

Block 101 may include obtaining an information technology (IT) system inventory dataset, which may be performed as an aspect of a vulnerability scan operation. For example, block 101 may include accessing a database or other data storage to retrieve IT system inventory data. As another example, block 101 may include scanning an IT system infrastructure to create the inventory dataset. Block 101 may include retrieving the data set from another executable process, such as an IT management software application. For instance, block 101 may comprise interfacing with an IT management software API (Application Programming Interface), issuing queries to a database application, gathering data via inspection process, or other suitable method.

The IT system inventory dataset may comprise data about any aspect or subsystem of the IT system, such as device information, software information, firmware information, configuration information, etc. For instance, a dataset may comprise inventory data regarding network firewall devices having a particular firmware version, system-managed smartphone operating systems, assets having or lacking a particular patch, end-of-life assets, configurations of email applications associated with IT system user accounts, flow tables of SDN (Software Defined Networking) deployments, etc. As another example, the inventory dataset may comprise information identifying running instances of an application.

Block 102 may include obtaining a vulnerability dataset. For example, block 102 may include receiving a vulnerability report from a vendor, a 3^{rd} party-maintained vulnerability list, an internally maintained vulnerability information, etc. For example, block 102 may comprise retrieving a vulnerability list as a file such as a spreadsheet (e.g., as a common separated list, formatted table(s), etc.), an EDI (Electronic Data Interchange) standard formatted message (e.g. a json (Javascript Object Notation) file, xml (eXtensible Markup Language) file, etc.), etc. As another example, block 102 may comprise retrieving a vulnerability list via an API, parsing a security bulletin (e.g., via a semantic language processing model, such as an LLM (Large Language Model), etc.), etc.

Block 103 may include determining a vulnerability for remediation based on the vulnerability dataset and the IT system inventory dataset. In some cases, block 103 may comprise performing a vulnerability analysis (e.g., an inventory scan against one or more vulnerabilities) to determine a vulnerability for remediation. For example, block 103 may comprise performing a software vulnerability identifying process, such as DAST (Dynamic Application Security Test), a SAST (Static Application Security Test), SCA (Software Composition Analysis). As another example, block 103 may include performing a network vulnerability analysis, a storage system vulnerability analysis, a hardware vulnerability analysis, etc. In some cases, block 103 may comprise performing a targeted vulnerability identification. For instance, the vulnerability dataset obtained in block 102 may comprise a zero-day vulnerability alert and block 103 may comprise performing an inventory assessment to determine if any assets are implicated in the alert. As another example, determining a vulnerability for remediation may include prioritizing a previously identified vulnerability. For example, block 103 may include selecting a vulnerability for prioritized remediation from a set of known existing vulnerabilities.

Block 104 may include using a reinforcement machine learning agent to determine a remediation confidence score for the vulnerability. A remediation confidence score may be an indicator of likelihood for a successful remediation for the vulnerability. In some examples, the remediation confidence score may be independent of a remediation modality. In further examples, the remediation confidence score may be dependent on a particular remediation modality. In still further examples, the remediation confidence score may be one of a plurality of confidence scores associated with a corresponding plurality of potential remediation modalities. Remediation modalities may include any suitable manner of addressing an IT system security vulnerability. For instance, remediation modalities may comprise remediation via patching, which includes any installation/modification of code to remedy a vulnerability, such as software bug fixes, upgrades, or updates, firmware upgrades, configuration updates, changing settings, restoring an application/data from a backup, etc. As another example, remediation modalities may comprise remediation via vulnerability compensation, which includes any modification of the IT system infrastructure to compensate for the vulnerability, such as configuring a network firewall or WAF (web application firewall) to eliminate an attack surface, removing the vulnerable component from a production architecture, isolating a vulnerable component (e.g., disabling a connection or connection protocol, etc.), etc. As further non-limiting examples, remediation may include operating system patching (e.g., Windows, Red Hat Enterprise Linux, etc.), application library updates (e.g., Java Development Kit, Apache, Python, etc.), implementation of multi-factor authentication, geo-blocking, whitelisting, blacklisting, etc.

Block 104 may be performed by a reinforcement machine learning (RL) agent based on results of past remediation operations and information included in various data sets. For example, the RL agent may be instantiated on a non-transitory computer readable medium and executed by a computer system, such as an IT administration/security computer system. For example, the RL agent may comprise a model-based agent, model-free agent, a combination thereof, or any other RL agent. For instance, a model-free RL agent may comprise a policy optimization (e.g., A2C/A3C, PPO, etc.) agent, Q-learning agent (e.g., DQN, C51, etc.), combinations (e.g., DDPG, SAC, etc.), a pure planning/model-predictive control agent (e.g., MBMF,12A, MBVE, etc.), an expert iteration agent, etc. In some examples, the RL agent may comprise a deep RL agent. For instance, the agent may include a deep model-based RL agent where IT system dynamics (e.g., vulnerability remediation dynamics) are modeled via a neural network or other AI (Artificial Intelligence) model, which may then be provided as an environmental model for an RL agent, such as a model predictive agent. As another example, the agent may include a deep model-free RL agent, such as a dynamic programming RL agent, where a predictive return is provided via a neural network function (e.g., a Q-function) that operates using a system state as an input. Of course, this not an exhaustive list of RL agents that may be included in implementations of the technology; any suitable RL framework may be employed.

Block 104 may include evaluating the IT system inventory dataset to determine the remediation confidence score. For example, the IT system inventory dataset may comprise historical remediation success data associated with assets, agent-generated/administrator provided policies associated with assets, asset dependencies, asset impact values, etc. For example, the inventory dataset may include an impact value associated with the importance of an asset, such as a manually provided or automatically determined business criticality indicator. Such impact values may be provided in any format, such as a number value within a range, binary value (e.g., important/not important), etc. As another example, the IT system inventory dataset may include policies associated with specific asset instances (e.g., a policy not to update a particular database), asset types (e.g., a policy to compensate for a vulnerability in a desktop program), etc.

Block 104 may include evaluating the vulnerability dataset to determine the remediation confidence score. In some cases, the vulnerability dataset may include information indicative of the probability for a successful remediation. For example, the vulnerability dataset may comprise historical data indicative of the success of previous attempts to remedy the vulnerability. For instance, such data may be received from third party/external sources, from internal testing, from internal past deployments, etc. As another example, the vulnerability dataset may include historical data or other empirical data regarding other vulnerability remedies for the associated asset. For instance, such data may include information regarding the success of past patches applied to a particular asset. As another example, the vulnerability dataset may include metadata regarding the vulnerability that may be indicative of likely success. For instance, the vulnerability metadata may include information regarding other patch code from the same source for other vulnerability remedies.

The RL agent may generate a confidence score as a policy/action output based on information contained in the inventory or vulnerability dataset. The confidence score may have any suitable format, such as an integer from a scale (e.g., a 0-5 scale, 1-3 scale, 1-10 scale, etc.), a continuous or decimal value, a probability estimate value, etc. The confidence score may relate to a particular vulnerability remediation process (e.g., confidence for a patching operation, confidence for a compensation operation, etc.). As an example, the RL agent may provide an outcome probability distribution of potential remediation actions. The RL agent may be trained based on various reward values. For example, the RL agent may be trained based on reward values derived from a correctly predicted remediation (e.g., based on successful/unsuccessful results of a remediation action). As another example, the RL agent may be trained based on a remediation action selected by a subsequent supervised learning model output, as described further below. For instance, reward values may be based on whether a selected remediation action accords with the remediation confidence score. For instance, if the RL agent outputs a high confidence value for a patching operation, but the supervised learning model selects a compensation operation, then the RL agent may be provided with a relatively lower reward value than if the supervised learning model were to select a patching operation. As a further example, the vulnerability dataset may include explanatory or background information regarding patches. If a particular patch for an asset lacks information or has faced difficulties in the past, then the RL agent may output a low confidence of remediation via a patch.

The RL agent may be trained in various manners. For example, the RL agent may be trained on a dataset derived from historical data regarding vulnerability remediation, such as historical remediation data associated with the IT system or obtained from an external source. As another example, the RL agent may be trained on a synthesized dataset, such as one derived from historical datasets with missing values/parameters manually provided or otherwise derived. As another example, the RL agent may be trained on a virtualized/sandboxed model system. For instance, the RL agent may be trained via self-experimentation in sandboxed environments comprising instances of similar assets to the production IT system.

Block 105 may include using a supervised machine learning (SL) agent to determine a remediation action for the vulnerability based on the confidence score. For example, block 105 may comprise applying the SL agent to the IT system inventory dataset and the confidence score. For example, block 105 may include selecting a remediation action to address the vulnerability. For instance, block 105 may comprise determining whether to perform a vulnerability on in a sandboxed environment or a production environment. As another example, block 105 may comprise selecting a type of action to perform. For instance, block 105 may comprise selecting a patching remediation procedure or a compensation remediation procedure. In further examples, block 105 may include selecting a manual procedure (e.g., flagging the vulnerability for manual remediation, etc.).

In some examples, block 105 may include determining parameters for the remediation procedure. For instance, block 105 may include determining a particular department or entity to conduct a remediation procedure (e.g., in a manual recommendation). For example, the SL agent may determine a party to conduct the remediation based on impact values contained in the inventory dataset or designated entity recorded in the dataset.

The SL agent may operate on any available data, including the dataset operated on by the RL agent in block 104, a subset of such data, separate data, etc. For instance, the SL agent may select the remediation action based on impact value scores included in the IT system inventory dataset. For example, the SL agent may output a recommendation to conduct a firewalling operation, source code remediation, OS patching operation, etc. in a production environment for a particular instance of an asset (e.g., a particular program or computer system within the IT system) based on a low impact value score and a high confidence score. In this same example, the SL agent might output a recommendation to conduct the remediation operation in a non-production test environment based on a high impact score and the high confidence score.

The SL agent may be implemented as a computer program stored on a non-transitory computer readable medium and executed by a computer system (e.g., a processor, virtual machine, container, etc.). The SL agent may be implemented according to any supervised machine learning framework, such as a neural network, support-vector machine, similarity function, decision tree, reservoir computer, etc. For example, the SL agent may comprise a deep neural network, such as a multilayer perceptron, recurrent neural network, etc.

The SL agent may be trained on any suitable labeled dataset. For example, the training dataset may include all or a portion of the training dataset used to train the RL agent with added ground truth labels (e.g., manually labeled or automatically labeled) and confidence scores associated with the training vulnerability data. As another example, the training dataset may be a synthesized dataset, such as a dataset including confidence values output by the RL agent (or synthesized to mimic such outputs), synthesized remediation action data, and synthesized impact values for assets implicated by the synthesized remediation actions. As another example, the training dataset may include historical data obtained via an external third-party source, past vulnerability remediation in the IT system, etc.

Block 106 may include performing the remediation action. For example, block 106 may include performing an automated patching operation in the production environment. For instance, block 106 may include executing patching scripts or other instructions to perform the patching operation. As another example, block 106 may include performing an automated compensation operation in the production environment. For instance, block 106 may include automatedly configuring a WAF to isolate a vulnerable asset or prevent access from a potential malicious actor. In some examples, block 106 may include performing the remediation action in a sandboxed environment before performing the remediation action in the production environment. For example, block 106 may comprise deploying a patch remedy in a sandboxed environment for testing prior to deployment in the production environment. As another example, block 106 may comprise isolating the component, removing the component, or other compensation operation in a sandboxed environment for testing prior to deployment in the production environment. As a further example, block 106 may include manually implementing the remedial action using normal IT systems vulnerability management techniques.

Block 107 may include updating the RL agent based on an outcome of performing the remediation action. For example, block 107 may include updating the RL agent by providing a reward value to the RL agent based on the outcome. For example, block 107 may include providing the RL agent a positive reward value for a successful remediation outcome and a negative reward value for an unsuccessful remediation action. As another example, block 107 may include updating environment or state data based on the outcome. For example, block 107 may include updating inventory data to indicate a dependency chain if the remediation action effected unintended systems, etc. In some examples, the update may be based on information gathered after the remediation action. For instance, an IT case management system may generate a matter for the vulnerability (e.g., a “ticket”). In this example the update may be based on information entered manually during a ticket closing process (e.g., as a template, questionnaire, field, etc.). As another example, the update may be based on information gathered during a subsequent vulnerability scan after the remediation action. For instance, the update may include information such as the failure or success of a patch application, or an impact on system behavior.

FIG. 2 provides an example flowchart 200 illustrating various aspects of an AI vulnerability management architecture. For example, flowchart 200 may illustrative of method 100 of FIG. 1. Of course, while illustrated with respect to various functional blocks, the technology is not limited to any particular architectural arrangement. Different blocks may be performed by single components, a single block may be performed by multiple components, datasets may be combined into common databases/structures, or separated in dedicated data structures, etc. Unless context indicates otherwise, the illustrated functions may be performed via executable code stored on non-transitory computer readable media and executed by one or more processors.

Block 201 includes an AI vulnerability management (AVM) process. For example, block 201 may include an RL agent process, an SL agent process, etc. Of course, while described as separate processes, the RL agent and the SL agent may be aspects of a combined model, or any other suitable AI framework. AVM 201 may output a recommended remediation action 212, 213, 216, 217, 218, 219 based on various data obtained from various datasets 202-210, 215.

Block 211 may include a vulnerability scan process to detect a vulnerability to output to AVM 201. For example, vulnerability scan 211 may comprise an automated vulnerability test, such as a DAST, SAST, network scan, hardware scan, etc. Vulnerability scan process 211 may be performed based on various input datasets, such as data listing assets to scan 208, data detailing vulnerabilities to scan for 209, compliance data 210, etc. For example, compliance data 210 may include data detailing various compliance policies/levels, security hardening details, configurations, etc. Identified vulnerabilities and impacted assets may be provided to AVM 201 by vulnerability scan 211.

Various other information may be used by AVM 201 to determine the remedial action. Various examples described below provide hypothetical examples to illustrate the breadth of environmental parameters that may be used by AVM 201. As known, it may be generally difficult to identify the weights that particular parameters used by an ML process (e.g., in a deep neural network) are given. Description of AVM 201 providing an output based on various input data should be understood as referring to availability of the input data for the AVM 201 to learn from. For example, an AVM 201 provided particular zero day information 203 as an input (as described below) may described as providing a remedy action output based on the zero day information, regardless of such information influences any model parameters or values.

For example, patch data 202 may be used to determine the remedial action. For example, patch data 202 may be retrieved from historical outcome data 215 (as discussed below), an external website (e.g., a vendor website for the asset), a third-party source, internal patch (e.g., coded by the IT system personnel), etc. The patch data may include various information, such as lists of affected products and versions, identification of vulnerabilities addressed by a patch, lists of patches in a grouped patch (e.g., a critical patch update), a summary of patch information (e.g., from an executive summary/analysis document), risk data related to patches (e.g., risk matrix data), alternatives to patching described in patch documentation (e.g., workarounds described in a patch document), credit statements (e.g., lists of people or organizations that identified the vulnerability addressed by the patch), support notes/policies, metadata for any of the prior, etc. AVM 201 may use any or all of such information to generate a remediation confidence score or to recommend a remediation action. For instance, AVM 201 might learn via machine learning processes that patches that affect a group of systems but not others are more likely to be remediable via patching while patches that some but not all of the group of systems are less likely to be remediable via patching. As another example, AVM 201 might learn that patches addressing vulnerabilities reported by a particular organization are more likely to be remedied via compensation rather than patches.

In some examples, AVM 201 may obtain data 203 regarding zero day vulnerabilities. For example, AVM 201 may be provided zero-day vulnerabilities independently of vulnerability scan process 211. For example, zero-day data 203 may be received from an external organization (e.g., a zero-day vulnerability tracking organization), a vendor, etc. Zero-day data 203 may include any information available, such as advisory narrative text (e.g., for analysis via an LLM component of AVM 201), vulnerable component identifier, vulnerability identifier, severity score (e.g. a CVSS (Common Vulnerability Scoring System) score), vulnerability classifier, a description, a notice of whether the vulnerability is being exploited, etc. Additionally or alternatively, scan asset data 208, vulnerability data 209, compliance data 210 may be obtained by AVM 201. For example, data 208-210 may be obtained in addition to vulnerability scan 211 output data. As another example, data 208-210 may be obtained without a vulnerability scan 211. For instance, vulnerability scan process 211 may be performed as an aspect of AVM process 201.

In some examples, AVM 201 may obtain inventory data 204. For example, inventory data 204 may include data regarding the IT system inventory, such as machine identifiers, installed programs; version information; operating system information; network applications, source codes, configurations, etc.; storage system inventory data; etc. In some cases, inventory data 204 may include additional information, such as policies for particular assets, risk/importance levels for assets or other impact values, historical remediation data (e.g., successful or unsuccessful past patch attempts), manually provided labels/tags (e.g., as ground truth values, environmental values, overriding policies, etc.), organizational data, owner information (e.g., a group/entity within the organization responsible the asset), other assets implicated/related to an asset, etc.

In some examples, AVM 201 may obtain firewall data 205. For example, firewall data 205 may include identifiers of assets that may be firewalled, firewall policy information, historical remediation success data, vulnerability classes or identifiers that may be remedied via firewalls, existing firewall instances/configurations, etc. In some examples, AVM 201 may obtain data regarding other compensation remediation data 206. For example, compensation data 206 may include assets or asset categories that may be automatedly isolated, past compensation remedy data (e.g., success/failure, numbers of remediations, etc.).

In some examples, AVM 201 may obtain impact data 207. For example, impact 207 may comprise severity or risk data associated with a vulnerability, asset importance data, historical risk/severity data, etc. In some examples, data 207 may be obtained as aspects of other data, as described above. In further examples, data 207 may be obtained independently. For instance, impact data 207 might include mappings that may be cross-referenced with any other data, such as an association of organizations with importance values, an association of a preferred sandbox policy with a network equipment type, etc.

Generally, AVM 201 may obtain data 215 related to outcomes of remediation actions. For example, outcome data 215 may comprise fields used as reward values (or to derive reward values) for an RL agent. As another example, outcome data 215 may comprise labeled outcome data used to update (or retrain) an SL agent.

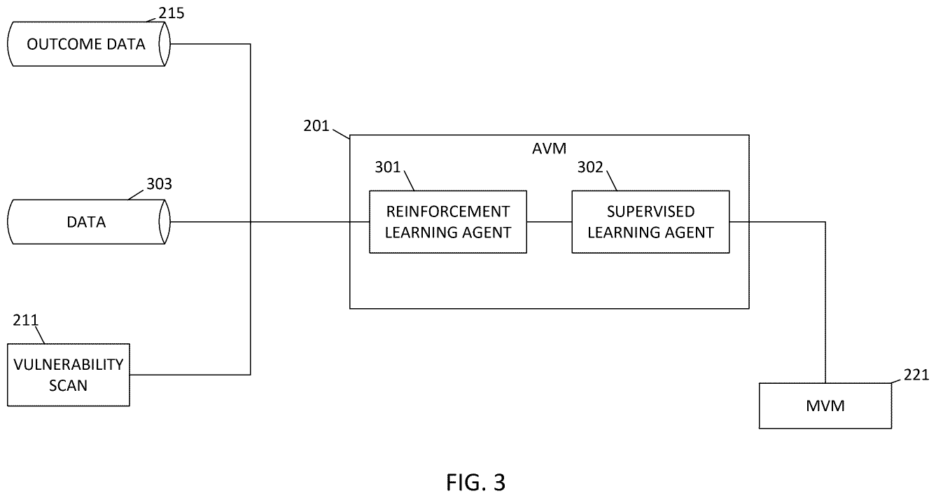

An example AVM 201 is described further below with respect to FIG. 3. Generally, AVM 201 may comprise any artificial intelligence/machine learning model to output a recommend remediation action. For instance, AVM 201 may comprise a classifier to output the remediation action as a classification. As another example, AVM 201 may comprise a decision tree to output the remediation action as a branch outcome for a tree traversal. AVM 201 may generate a recommended remediation action 212, 213, 216, 217, 218, 219, etc. While various examples of remediation actions are provided below, the technology is not limited to any particular group of remediation actions.

Any vulnerability remediation action may be included as a potential output of AVM 201. Further, the output may comprise any other information, such as information to assist the remediation process. For example, the AVM 201 might output a routing table for an automated reconfiguration of a network device, a network identifier for an application to protected by a WAF, a resource locator for patch code to be applied, etc. Further, AVM 201 may trigger multiple remediation actions in parallel or sequence. Additionally, AVM 201 may have additional outputs or perform additional actions based on its recommended remedial action. For instance, AVM 201 may generate a ticket in a case management system, update an existing ticket, trigger a notification to an assigned entity, etc. In some examples, AVM 201 may trigger the execution of remediation actions, deployment of sandboxes, etc., which may be performed with or without manual confirmation. As another example, AVM 201 may output a recommendation for a remediation action to be considered by IT system security members, etc. For ease of explanation, the performance of an action responsive to AVM 201's output will be described as “triggered.”

As an example, AVM 201 may trigger an automated compensation action 212. For example, automated compensation 212 may comprise automatedly implementing a workaround (e.g., isolation, restoration, reconfiguration, etc.) in the IT system production environment (e.g., the IT systems used to conduct the organization's operations). For example, compensation 212 may include configuring a network firewall, WAF, gateway, whitelist/blacklist/geo-block list, etc. As another example, automated compensation 212 may comprise automatedly isolating an asset, depowering an asset, restoring an asset from a backup, etc. As another example, automated compensation 212 may include configuring a workaround (e.g., disabling an optional instruction from an instruction set architecture, etc.), applying obfuscation code, segmentation, etc.

As an example, AVM 201 may trigger an automated patching action 213. For example, patching action 213 may include retrieving patch code (e.g., updates, security patches, firmware, down versioned code, etc.), such as from patch data 202 (e.g., from a URL included in patch data 202) or from AVM 201, as described above. Automated patching action 213 may include any process for deploying patch code. For instance, patching action 213 may include triggering a machine update (e.g., to upgrade to an unimpacted version, for the machine to retrieve and install the patch code from a source, etc.), firmware installation, configuration code, etc. As another example, patching action 213 may comprise installing the patch code directly (e.g., via remote administration of affected assets) in the production environment.

Responsive to completion of an automated remediation action 212, 213, process 214 may be performed to determine if the remediation action was successful. For instance, process 214 may include automated testing/scanning, manual confirmation, etc. Data 215 regarding the outcome of the remediation action may be output responsive to the success test 214. The outcome data 215 may include any potential data obtained as an aspect of the remediation process 212, 213. For example, outcome data 215 may include identifiers of affected system, numbers of systems, telemetry, logs, etc. Following a successful test 214, the IT system may undergo a second scan 211. If further vulnerabilities are detected, the AVM process 201 may be performed again for a next vulnerability remediation. Similarly, if test 214 fails, AVM 201 may conduct another analysis and trigger a second remediation action.

This subsequent analysis may be performed in view of the additional outcome data 215 generated by the failed process. For example, the failed test outcome data may be used as a reward value or to derive a reward value to update a reinforcement learning agent. As another example, the outcome data 215 may be labeled as a failed test and the labeled data may be used to update a supervised learning agent. As a further example, the outcome data 215 may be used to exclude the previous remediation action from consideration.

In some examples, AVM 201 may trigger sandboxed remediation actions 216, 217 to test a remediation action in an isolated testing environment prior to deploying the remediation in the production environment. For example, AVM 201 may trigger a sandboxed compensation operation 216. Similarly, AVM 201 may trigger a sandboxed patching operation 217. Respective sandbox testing 223, 224 may be performed on the sandbox environment following the sandboxed remediation action. Sandbox testing 223, 224 may include any suitable security/operational testing procedure, including execution of test scripts, performing system scans, manual interaction, etc. Responsive to completion of the sandboxed remediation 216, 217 (e.g., following testing 223, 224), the outcome may be tested 214. Following a successful test, the system may implement an automated compensation operation 212 or an automated patching operation 213 in the production environment.

In some examples, AVM 201 may determine that an automated remediation action should not be performed. For example, AVM 201 may forgo an automated action based on a low confidence score associated with a vulnerability, a stored policy (e.g., a rule that all vulnerabilities effecting a certain department should be attended to manually), etc. For example, AVM 201 may trigger a manual remediation process 218. For example, in an implementation accompanying a ticket management system, the manual remediation process 218 may be triggered by editing the ticket to be sent to a case queue for manual remediation. As another example, AVM 201 decide that remediation is unlikely or otherwise decide that a vulnerability should be attended to with elevated intervention 219. For example, AVM 201 may be programmed to flag a case in case of threshold joint values of risk and confidence (e.g., a high risk with low confidence), based on a particular policy, other programmed rule, learned behavior, etc. In some examples, manual remediation process 218 may include providing an output to a case management system 222. For example, an MVM (Managed Vulnerability Mitigation) report or other formatted data may be provided to a case management system 222, to security personnel (e.g., to an admin messaging channel/email account, etc.), etc. Accordingly, examples may be deployable in IT security systems without substantial reorganization/modification to existing infrastructure.

In some examples, a dashboard process 229 may generate graphical indicators of various aspects of the system. For instance, dashboard process 229 may provide an IT security system status (e.g., progress/service levels), a comparison (e.g., cost savings) of the AVM 201 implemented security system compared to a traditional system, data regarding particular remediation actions (e.g., percentage/number of manual remediations, automated patches, etc.), data regarding various organizational policies/compliance requirements, vulnerability remediation in view of risk/severity value, etc.

FIG. 3 illustrates aspects of an implementation of AVM 201. As illustrated, the AVM process 201 is interposed between vulnerability scan process 211 and MV process 221. Accordingly, as described above, an AVM process 201 may be incorporated into an existing security infrastructure as a shim in an existing channel between the vulnerability scan process 211 and MVM 221. Of course, the technology is not so limited and an AVM 201 may be implemented in any architectural role, as an aspect of vulnerability scan process 211 or MVM process 221, etc.

In this example, AVM 201 includes a reinforcement learning (RL) agent 301 and a supervised learning (SL) agent 302. For example, RL agent 301 may start an analysis responsive to receiving an instruction regarding a vulnerability to remedy (e.g., from vulnerability scan process 211, MVM process 221, previous remedy attempt failure, etc.). RL may analyze the vulnerability in view of an environment including data from various datasets 303. For example, RL agent 301 may operate as described with respect to block 104 to determine a remediation confidence score for the vulnerability. Data 303 may include any data described herein, such as data 202-210 or any data described with respect to method 100. For example, data 303 may include data received from vulnerability scan process 211, software inventor data, patch-related data, network data, risk/severity dtaa, firewall data, other compensation-related data, vulnerability reports, zero day vulnerability data, system type data, etc.

RL agent 301 may comprise a model-based agent, model-free agent, a combination thereof, or any other RL agent. For instance, a model-free RL agent may comprise a policy optimization (e.g., A2C/A3C, PPO, etc.) agent, Q-learning agent (e.g., DQN, C51, etc.), combinations (e.g., DDPG, SAC, etc.), a pure planning/model-predictive control agent (e.g., MBMF,12A, MBVE, etc.), an expert iteration agent, etc. In some examples, the RL agent may comprise a deep RL agent. For instance, the agent may include a deep model-based RL agent where IT system dynamics (e.g., vulnerability remediation dynamics) are modeled via a neural network or other AI (Artificial Intelligence) model, why may then be provided as an environmental model for an RL agent, such as a model predictive agent. As another example, the agent may include a deep model-free RL agent, such as a dynamic programming RL agent, where a predictive return is provided via a neural network function (e.g., a Q-function) that operates using a system state as an input. Of course, this not an exhaustive list of RL agents that may be included in implementations of the technology; any suitable RL framework may be employed.

SL agent 302 may determine a remediation action based on the remedy confidence score provided by RL agent 301. SL agent may determine the remediation action based on the confidence score and other various other data. For example, SL agent 302 may operate as described with respect to block 105. For example, SL agent 302 may determine a remedy action based on patch data, compensation data, asset owner data, scope data, identifiers for manual remediation (e.g., parties associated with an asset, department, etc.), etc.

AVM 201 may, as described above, output information to MVM 221. For example, AVM 201 may output data such as patch data, compensation data, affected owner/scope data, inputs for a ticketing tool or other case management system, alerts/notifications, etc.

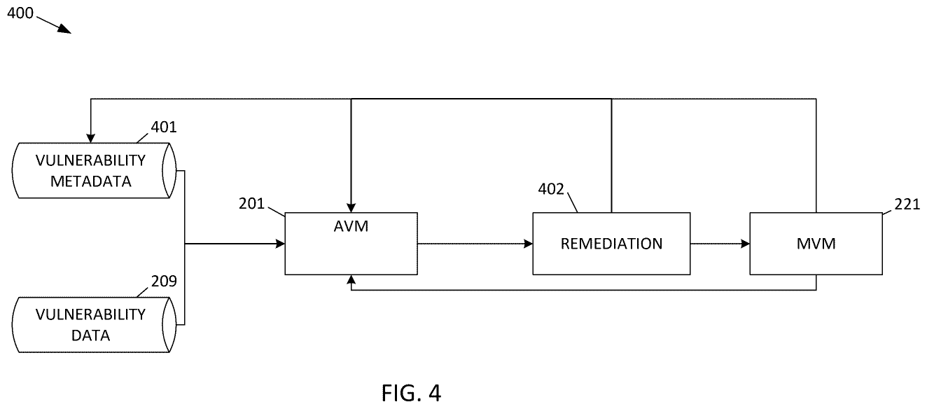

FIG. 4 illustrates an example process flow 400 for feedback processes in a system including an AVM 201 and MVM 221. In this example, AVM 201 triggers a remediation process 402 (e.g., process 212, 213, 216, 217, etc.) based on vulnerability data 209 and associated vulnerability metadata 401.

In the illustrated example, vulnerability metadata 401 may be generated by any system component. For instance, MVM 221 may provide severity/risk data, owner/scope information, etc., that may be associated with vulnerabilities 209. The outcome of remediation process 402 may further generate vulnerability metadata 401. For example, outcome metadata may include outcome values (e.g., a value indicative of a successful, failed, canceled, etc., logs, text or other inputs received from an administrator, ticket identifiers, etc.

In this example, various components may provide data to configure/train AVM 201. For example, remediation process 402 may provide reward values or labeled records based on the remediation outcome, as described above. As another example, MVM 221 may provide training data such as initial training datasets, labeled datasets, etc. As described above, AVM 201 may further execute/follow various policies. As illustrated, such policies may be provided via MVM 221.

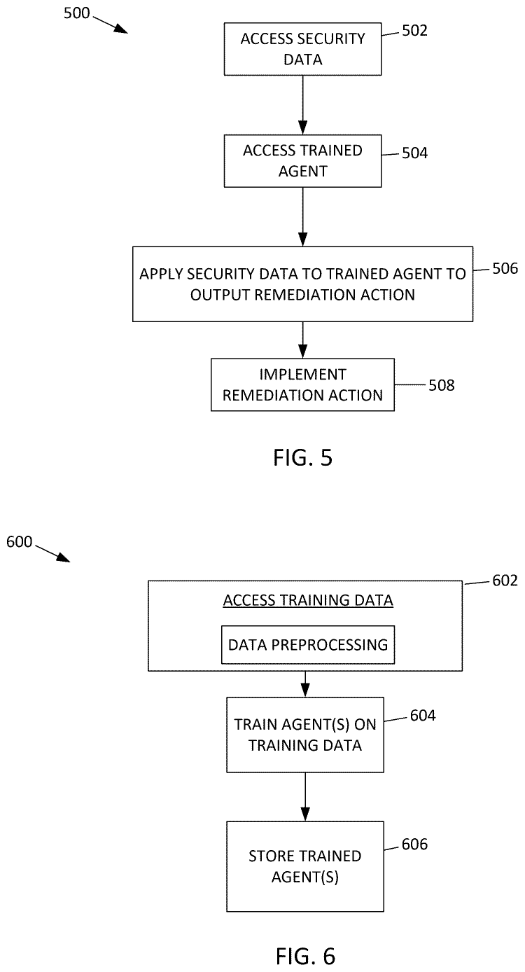

Referring now to FIG. 5, a flowchart is illustrated as setting forth the steps of an example method for vulnerability remediation using a suitably trained machine learning model, such as, for example, the RL and SL agents described with respect to FIGS. 1-4. As will be described, the machine learning agent takes security-related data (e.g., data 202-210 of FIG. 2) as input data and generates a trigger for a vulnerability remediation action as an output.

The method includes accessing security-related data with a computer system, as indicated at step 502. Accessing the security-related data may include retrieving such data from a memory or other suitable data storage device or medium. Additionally or alternatively, accessing the security-related data may include acquiring such data via a network connection, such as to the Internet, an internal organizational network, etc. As described above, the security-related data are generally vulnerability and asset related data, such as described with respect to data 202-210 of FIG. 2.

A trained machine learning agent (or other suitable machine learning model) is then accessed with the computer system, as indicated at step 504. In general, the machine learning agent is trained, or has been trained, on training data in order to identify vulnerability remedies and associated actions. This evaluation is achieved, in part, by the machine learning agent being trained via a training dataset as described above.

Accessing the trained machine learning agent may include accessing model parameters (e.g., weights, biases, or both) that have been optimized or otherwise estimated by training the machine learning agent on training data. In some instances, retrieving the machine learning agent can also include retrieving, constructing, or otherwise accessing the particular machine learning agent architecture to be implemented.

The security-related data are then input to the trained machine learning agent, generating output an indication of a particular remedial action, as indicated at step 506. For example, the remedial action may be as described with respect to actions 212, 213, 216, 217, 218, 219 of FIG. 2. The identified remedial action may then be implemented as indicated at step 508.

Referring now to FIG. 6, a flowchart is illustrated as setting forth the steps of an example method for training one or more machine learning agents (or other suitable machine learning models) on training data, such that the one or more machine learning agents are trained to receive security-related data as input data in order to generate remediation outcome identification as an output. For example, in some implementations, machine learning agent training may be performed on a computer system (e.g., system 200) prior to being instantiated in a production environment (e.g., AVM 201).

The method includes accessing training data with a computer system, as indicated at step 602. In general, the training data can include security-related data with ground truth annotations, target outcomes, etc. generated from input security-related data, including synthesized security-related data. Additionally or alternatively, the accessed training data can include security-related data received from an example database. Accessing the training data may include retrieving such data from a memory or other suitable data storage device or medium. The method can include assembling training data from security-related data using a computer system. This step may include assembling the security-related data into an appropriate data structure on which the machine learning agent can be trained. Assembling the training data may include annotating security-related data, providing training reward values, etc.

One or more machine learning agents are trained on the training data, as indicated at step 604. Training a machine learning agent may include initializing the machine learning agent, such as by computing, estimating, or otherwise selecting initial model parameters (e.g., policies, environments, weights, biases, or both). During training, a machine learning agent receives the inputs for a training example and generates an output. The machine learning agent then compares the generated output with a ground truth value of the training example in order to evaluate the quality of the generated outcome. For instance, the outcome output data can be passed to a loss function to compute an error. The current machine learning agent can then be updated based on the calculated error (e.g., using backpropagation methods based on the calculated error). For instance, the current machine learning agent can be updated by providing reward values or updating network parameters (e.g., weights, biases, or both) in order to minimize the loss according to the loss function. The training continues until a training condition is met. The training condition may correspond to, for example, a predetermined number of training examples being used, a minimum accuracy threshold being reached during training and validation, a predetermined number of validation iterations being completed, and the like. When the training condition has been met (e.g., by determining whether an error threshold or other stopping criterion has been satisfied), the current machine learning agent and its parameters represent the trained machine learning agent. The training processes may include, for example, gradient descent, Newton's method, conjugate gradient, quasi-Newton, Levenberg-Marquardt, among others.

The machine learning agent can be constructed or otherwise trained based on training data using one or more different learning techniques, such as supervised learning, unsupervised learning, reinforcement learning, ensemble learning, active learning, transfer learning, or other suitable learning techniques for machine learning agents. As an example, supervised learning involves presenting a computer system with example inputs and their actual outputs (e.g., categorizations). In these instances, the machine learning agent is configured to learn a general rule or model that maps the inputs to the outputs based on the provided example input-output pairs.

The one or more trained machine learning agents are then stored for later use, as indicated at step 606. Storing the machine learning agent(s) may include storing agent parameters, which have been computed or otherwise estimated by training the machine learning agent(s) on the training data. For example, storing the machine learning agent may include instantiating the machine learning agent in a computing environment, such as by programming a neuromorphic computer or storing machine learning agent parameters in a storage system, memory, FPGA, etc. Storing the trained machine learning agent(s) may also include storing the particular machine learning agent architecture to be implemented. For instance, data pertaining to layers in the machine learning agent architecture (e.g., number of layers, type of layers, ordering of layers, connections between layers, hyperparameters for layers) may be stored.

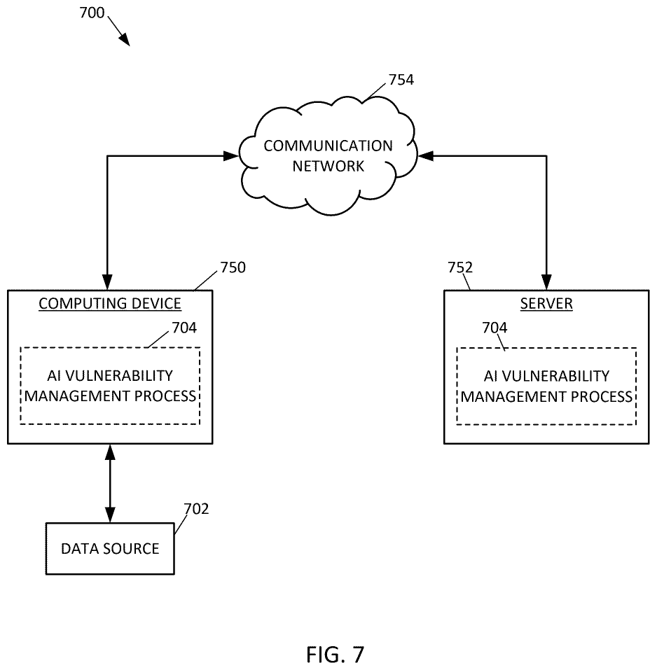

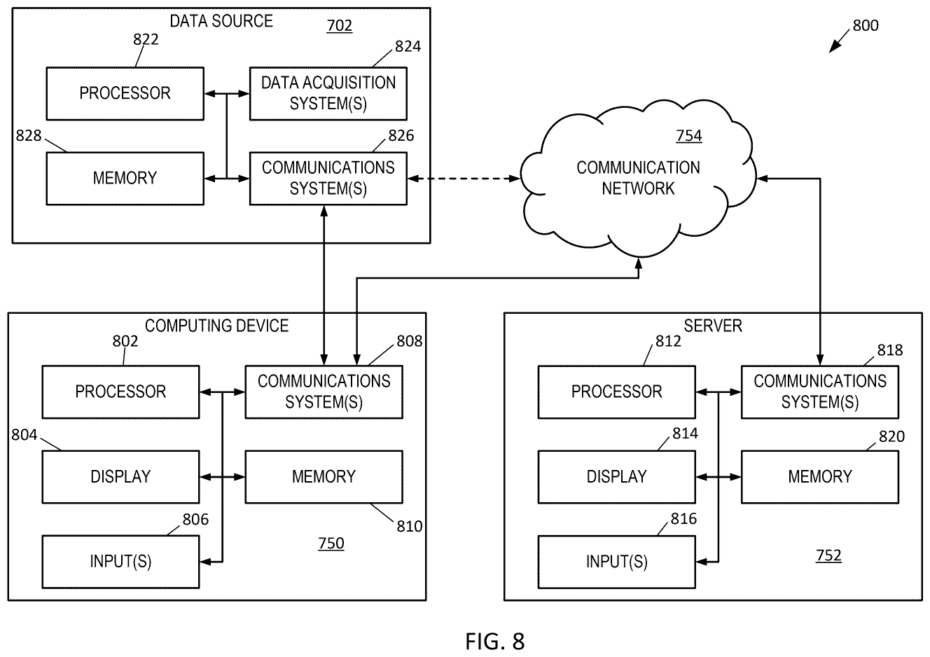

FIG. 7 shows an example of a system 700 for vulnerability remediation in accordance with some embodiments described in the present disclosure. As shown in FIG. 7, a computing device 750 can receive one or more types of data (e.g., security-related data) from data source 702. In some embodiments, computing device 750 can execute at least a portion of vulnerability remediation system 704 to generate remediation outcomes from data received from the data source 702. Additionally or alternatively, in some embodiments, the computing device 750 can communicate information about data received from the data source 702 to a server 752 over a communication network 754, which can execute at least a portion of the vulnerability remediation system 704.

In some embodiments, computing device 750 and/or server 752 can be any suitable computing device or combination of devices, such as a desktop computer, a laptop computer, a tablet computer, a server computer, a virtual machine being executed by a physical computing device, and so on.

In some embodiments, data source 702 can be any suitable source of data (e.g., vendor, third-party, internal datastore, data synthesizer, etc.). In some embodiments, data source 702 can be local to computing device 750. Additionally or alternatively, in some embodiments, data source 702 can be located locally and/or remotely from computing device 750, and can communicate data to computing device 750 (and/or server 752) via a communication network (e.g., communication network 754).

In some embodiments, communication network 754 can be any suitable communication network or combination of communication networks. For example, communication network 754 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 754 can be a local area network, a wide area network, a public network (e.g., the Internet), a private or semi-private network (e.g., a corporate or university intranet), any other suitable type of network, or any suitable combination of networks. Communications links shown in FIG. 7 can each be any suitable communications link or combination of communications links, such as wired links, fiber optic links, Wi-Fi links, Bluetooth links, cellular links, and so on.

Referring now to FIG. 8, an example of hardware 800 that can be used to implement data source 702, computing device 750, and server 752 in accordance with some embodiments of the systems and methods described in the present disclosure is shown.

As shown in FIG. 8, in some embodiments, computing device 750 can include a processor 802, a display 804, one or more inputs 806, one or more communication systems 808, and/or memory 810. In some embodiments, processor 802 can be any suitable hardware processor or combination of processors, such as a central processing unit (CPU), a graphics processing unit (GPU), and so on. In some embodiments, display 804 can include any suitable display devices, such as a liquid crystal display (LCD) screen, a light-emitting diode (LED) display, an organic LED (OLED) display, a computer monitor, a touchscreen, and so on. In some embodiments, inputs 806 can include any suitable input devices and/or sensors that can be used to receive user input, such as a keyboard, a mouse, a touchscreen, a microphone, and so on.

In some embodiments, communications systems 808 can include any suitable hardware, firmware, and/or software for communicating information over communication network 754 and/or any other suitable communication networks. For example, communications systems 808 can include one or more transceivers, one or more communication chips and/or chip sets, and so on. In a more particular example, communications systems 808 can include hardware, firmware, and/or software that can be used to establish a Wi-Fi connection, a Bluetooth connection, a cellular connection, an Ethernet connection, and so on.

In some embodiments, memory 810 can include any suitable storage device or devices that can be used to store instructions, values, data, or the like, that can be used, for example, by processor 802 to present content using display 804, to communicate with server 752 via communications system(s) 808, and so on. Memory 810 can include any suitable volatile memory, non-volatile memory, storage, or any suitable combination thereof. For example, memory 810 can include random-access memory (RAM), read-only memory (ROM), electrically programmable ROM (EPROM), electrically erasable ROM (EEPROM), other forms of volatile memory, other forms of non-volatile memory, one or more forms of semi-volatile memory, one or more flash drives, one or more hard disks, one or more solid state drives, one or more optical drives, and so on. In some embodiments, memory 810 can have encoded thereon, or otherwise stored therein, a computer program for controlling operation of computing device 750. In such embodiments, processor 802 can execute at least a portion of the computer program to present content (e.g., images, user interfaces, graphics, tables), receive content from server 752, transmit information to server 752, and so on. For example, the processor 802 and the memory 810 can be configured to perform the methods described herein (e.g., the method of FIG. 7, the method of FIG. 6).

In some embodiments, server 752 can include a processor 812, a display 814, one or more inputs 816, one or more communications systems 818, and/or memory 820. In some embodiments, processor 812 can be any suitable hardware processor or combination of processors, such as a CPU, a GPU, and so on. In some embodiments, display 814 can include any suitable display devices, such as an LCD screen, LED display, OLED display, electrophoretic display, a computer monitor, a touchscreen, a television, and so on. In some embodiments, inputs 816 can include any suitable input devices and/or sensors that can be used to receive user input, such as a keyboard, a mouse, a touchscreen, a microphone, and so on.

In some embodiments, communications systems 818 can include any suitable hardware, firmware, and/or software for communicating information over communication network 754 and/or any other suitable communication networks. For example, communications systems 818 can include one or more transceivers, one or more communication chips and/or chip sets, and so on. In a more particular example, communications systems 818 can include hardware, firmware, and/or software that can be used to establish a Wi-Fi connection, a Bluetooth connection, a cellular connection, an Ethernet connection, and so on.

In some embodiments, memory 820 can include any suitable storage device or devices that can be used to store instructions, values, data, or the like, that can be used, for example, by processor 812 to present content using display 814, to communicate with one or more computing devices 750, and so on. Memory 820 can include any suitable volatile memory, non-volatile memory, storage, or any suitable combination thereof. For example, memory 820 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 820 can have encoded thereon a server program for controlling operation of server 752. In such embodiments, processor 812 can execute at least a portion of the server program to transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone), and so on.

In some embodiments, the server 752 is configured to perform the methods described in the present disclosure. For example, the processor 812 and memory 820 can be configured to perform the methods described herein (e.g., the method of FIG. 7, the method of FIG. 6).

In some embodiments, data source 702 can include a processor 822, one or more data acquisition systems 824 (e.g., sensors), one or more communications systems 826, and/or memory 828. In some embodiments, processor 822 can be any suitable hardware processor or combination of processors, such as a CPU, a GPU, and so on. Additionally or alternatively, in some embodiments, the one or more data acquisition systems 824 can include any suitable hardware, firmware, and/or software for related to operations of an IT security system. In some embodiments, one or more portions of the data acquisition system(s) 824 can be removable and/or replaceable.

In some embodiments, communications systems 826 can include any suitable hardware, firmware, and/or software for communicating information to computing device 750 (and, in some embodiments, over communication network 754 and/or any other suitable communication networks). For example, communications systems 826 can include one or more transceivers, one or more communication chips and/or chip sets, and so on. In a more particular example, communications systems 826 can include hardware, firmware, and/or software that can be used to establish a wired connection using any suitable port and/or communication standard (e.g., DVI video, USB, RS-232, etc.), Wi-Fi connection, a Bluetooth connection, a cellular connection, an Ethernet connection, and so on.

In some embodiments, memory 828 can include any suitable storage device or devices that can be used to store instructions, values, data, or the like, that can be used, for example, by processor 822 to control the one or more data acquisition systems 824, and/or receive data from the one or more data acquisition systems 824; to generate images from data; present content (e.g., data, images, a user interface) using a display; communicate with one or more computing devices 750; and so on. Memory 828 can include any suitable volatile memory, non-volatile memory, storage, or any suitable combination thereof. For example, memory 828 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 828 can have encoded thereon, or otherwise stored therein, a program for controlling operation of data source 702. In such embodiments, processor 822 can execute at least a portion of the program to generate images, transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

What is claimed is:

1. A method, comprising:
obtaining an information technology (IT) system inventory dataset;
obtaining a vulnerability dataset;
determining a vulnerability for remediation based on the vulnerability dataset and the IT system inventory dataset;
evaluating the IT system inventory dataset using a reinforcement machine learning agent to determine a remediation confidence score for the vulnerability;
evaluating the remediation confidence score and the IT system inventory dataset using a supervised machine learning agent to determine a remediation action for the vulnerability;
performing the remediation action; and
updating the reinforcement machine learning agent based on an outcome of performing the remediation action.

2. The method of claim 1, wherein the remediation action comprises an automated vulnerability compensation operation, an automated patching operation, a sandboxed vulnerability compensation operation, or a sandboxed patching operation, or a manual remediation operation.

3. The method of claim 1, wherein:
the IT system inventory dataset comprises impact value data for the IT system inventory, and
evaluating the IT system inventory data using the supervised machine learning agent comprises evaluating the impact value data using the supervised machine learning agent.

4. The method of claim 1, wherein the vulnerability dataset comprises potential remediation actions for the vulnerability, and further comprising:
evaluating the potential remediation actions for the vulnerability using the reinforcement machine learning agent to determine the remediation confidence score.

5. The method of claim 4, further comprising determining a corresponding remediation confidence score for each of the potential remediation actions.

6. The method of claim 1, further comprising updating the IT system inventory dataset associated with an inventory asset or an inventory asset type to include the outcome of performing the remediation.

7. The method of claim 1, further comprising, responsive to a negative outcome of preforming the remedial action:
determining an updated remediation confidence score using the updated reinforcement machine learning agent;
determining an updated remediation action using the supervised machine learning agent and the updated remediation confidence score;
performing the updated remediation action; and
updating the updated reinforcement machine learning agent based on an updated remediation action outcome.

8. The method of claim 1, wherein the vulnerability dataset comprises empirical data associated with the vulnerability and further comprising:
evaluating the empirical data associated with the vulnerability using the reinforcement machine learning agent to determine the remediation confidence score; and
updating the empirical data based on the outcome.

9. A system, comprising:
at least one processor;
a non-transitory computer readable medium storing instructions executable by the at least one processor to:
obtain an information technology (IT) system inventory dataset;
obtain a vulnerability dataset;
determine a vulnerability for remediation based on the vulnerability dataset and the IT system inventory dataset;
evaluate the IT system inventory dataset using a reinforcement machine learning agent to determine a remediation confidence score for the vulnerability;
evaluate the remediation confidence score and the IT system inventory dataset using a supervised machine learning agent to determine a remediation action for the vulnerability;
output the remediation action;
receive an outcome of performing the remediation action; and
update the reinforcement machine learning agent based on the outcome.

10. The system of claim 9, wherein:
the IT system inventory dataset comprises impact value data for the IT system inventory, and
the instructions are executable to evaluate the impact value data using the supervised machine learning agent.

11. The system of claim 9, wherein the vulnerability dataset comprises potential remediation actions for the vulnerability, and the instructions are executable to evaluate the potential remediation actions for the vulnerability using the reinforcement machine learning agent to determine the remediation confidence score.

12. The system of claim 11, wherein the instructions are further executable to determine a corresponding remediation confidence score for each of the potential remediation actions.

13. The system of claim 9, wherein the instructions are executable to, responsive to a negative outcome of preforming the remedial action:
determine an updated remediation confidence score using the updated reinforcement machine learning agent;
determine an updated remediation action using the supervised machine learning agent and the updated remediation confidence score;
perform the updated remediation action; and
update the updated reinforcement machine learning agent based on an updated remediation action outcome.

14. The system of claim 9, wherein the vulnerability data comprises empirical data associated with the vulnerability and the instructions are executable to:
evaluate the empirical data associated with the vulnerability using the reinforcement machine learning agent to determine the remediation confidence score; and
update the empirical data based on the outcome.

15. A non-transitory computer readable medium storing instructions executable by at least one processor to:
obtain an information technology (IT) system inventory dataset;
obtain a vulnerability dataset;
determine a vulnerability for remediation based on the vulnerability dataset and the IT system inventory dataset;
evaluate the IT system inventory dataset using a reinforcement machine learning agent to determine a remediation confidence score for the vulnerability;
evaluate the remediation confidence score and the IT system inventory dataset using a supervised machine learning agent to determine a remediation action for the vulnerability;
output the remediation action;
receive an outcome of performing the remediation action; and
update the reinforcement machine learning agent based on the outcome.

16. The non-transitory computer readable medium of claim 15, wherein:
the IT system inventory dataset comprises impact value data for the IT system inventory, and
the instructions are executable to evaluate the impact value data using the supervised machine learning agent.

17. The non-transitory computer readable medium of claim 15, wherein the vulnerability dataset comprises potential remediation actions for the vulnerability, and the instructions are executable to evaluate the potential remediation actions for the vulnerability using the reinforcement machine learning agent to determine the remediation confidence score.

18. The non-transitory computer readable medium of claim 17, wherein the instructions are further executable to determine a corresponding remediation confidence score for each of the potential remediation actions.

19. The non-transitory computer readable medium of claim 15, wherein the instructions are executable to, responsive to a negative outcome of preforming the remedial action:
determine an updated remediation confidence score using the updated reinforcement machine learning agent;
determine an updated remediation action using the supervised machine learning agent and the updated remediation confidence score;
perform the updated remediation action; and
update the updated reinforcement machine learning agent based on an updated remediation action outcome.

20. The non-transitory computer readable medium of claim 15, wherein the vulnerability data comprises empirical data associated with the vulnerability and the instructions are executable to:
evaluate the empirical data associated with the vulnerability using the reinforcement machine learning agent to determine the remediation confidence score; and
update the empirical data based on the outcome.
